(19) United States
(12) Patent Application Publication
(10) Pub. No.: US 2026/0223992 A1
(43) Pub. Date: Aug. 6, 2026

(54) MULTI FUNCTIONAL HIKING POLES

(71) Applicant: NINGBO ZENONE OUTDOOR PRODUCTS CO.,LTD, Ningbo (XN)

(72) Inventor: JIANLE LIN, Wenzhou (CN)

(21) Appl. No.: 19/632,193

(22) Filed: Mar. 28, 2026

(30) Foreign Application Priority Data
Nov. 5, 2025 (CN) 202522351197.X

(51) Int. Cl. A45B 3/00; A45B 9/04; G03B 17/56

(52) U.S. Cl. CPC A45B 3/00; A45B 9/04; G03B 17/561; A45B 2200/055

(57) ABSTRACT

Provided is a multifunctional trekking pole, which includes a cane tube, a connection rod, and a replaceable functional component. One end of the cane tube forms a handheld section, and the other end forms an installation section; one end of the connection rod forms a fixed section, and the other end forms an insertion section; the fixed section is inserted into the installation section, the functional component is provided with a heteroideus hole, and the insertion section is inserted into the heteroideus hole, the heteroideus hole limits a circumferential rotation of the functional component relative to the connection rod; the installation section is provided with a rotatable threaded cylinder, and the threaded cylinder is connected to the functional component by threads, thereby limiting an axial movement of the functional component relative to the connection rod, and the cane tube, the connection rod, and the functional component are connected.

### CROSS-REFERENCE TO RELATED APPLICATIONS

This application claims priority to Chinese Patent Application No. 202522351197.X, filed on November 05, 2025, which is hereby incorporated by reference in its entirety.

### TECHNICAL FIELD

The present disclosure relates to the field of trekking pole technologies, and in particular, to a multi-functional hiking pole.

### BACKGROUND

Trekking poles are auxiliary equipment used in mountaineering, which can share leg pressure and maintain balance, thereby improving the user’s walking efficiency. According to research, using a trekking pole during walking can bring many benefits to users during exercise, such as reducing pressure on the knee joint, improving walking stability, increasing walking speed, and self-defense.

In the existing technology, hiking poles include a cane tube, with a cane tip seat on the cane tube and a pole tip on the cane tip seat. The cane tip is mainly used for support, and the cane tip seat is connected to the cane tube as a whole, the two cannot be disassembled. Moreover, current hiking poles are only used for walking support and have a relatively single function.

### SUMMARY

The purpose of the present disclosure is to provide a multifunctional trekking pole, aiming to solve the problem of single function trekking poles in the prior art.

The present disclosure is implemented as follows: a multifunctional trekking pole, including: a cane tube, a connection rod, and a replaceable functional component, where one end of the cane tube forms a handheld section, and the other end of the cane tube forms an installation section; one end of the connection rod forms a fixed section, and the other end of the connection rod forms an insertion section;

the fixed section is inserted into the installation section, and the insertion section is exposed outside the installation section; the functional component is provided with a heteroideus hole, and the insertion section is inserted into the heteroideus hole, the heteroideus hole limits a circumferential rotation of the functional component relative to the connection rod;

the installation section is provided with a rotatable threaded cylinder, and the threaded cylinder is connected to the functional component by threads, thereby limiting an axial movement of the functional component relative to the connection rod, and the cane tube, the connection rod, and the functional component are connected.

In some embodiments of the present disclosure, a plurality of recess rings are formed on an outer circumference of the fixed section, the plurality of recess rings are arranged around a circumference of the fixed section, and the plurality of recess rings are arranged at intervals along an axial direction of the fixed section.

In some embodiments of the present disclosure, the plurality of recess rings are arranged at inclined to a central axis of the fixed section, and the plurality of recess rings are inclined in different directions from a central axis of the fixed section; bottoms of the recess rings have bottom ring walls, and two sides of the recess rings have side ring walls respectively; two of the side ring walls are arranged facing each other, and the two side ring walls surround the bottom ring walls to form the recess rings;

the recess rings are provided with a plurality of arc-shaped elastic strips, and the plurality of arc-shaped elastic strips are arranged around a circumference of the recess rings and spaced apart from each other; two sides of the elastic strips are respectively connected to the two side ring walls, and there is a deformation gap between the elastic strips and the bottom ring walls;

the deformation gap is provided with a plurality of elastic columns, and bottoms of the elastic columns are connected to the bottom ring walls; tops of the elastic columns pass through the elastic strips, and a hard pressing head is provided on the tops of the elastic columns;

the fixed section is inserted into the installation section, and the elastic strips are compressed and deformed towards the bottom ring walls;

the plurality of elastic columns are compressed and deformed synchronously, and a plurality of pressing heads are elastically abutted against the installation section, applying pressure to a plurality of positions on the installation section.

In some embodiments of the present disclosure, a positioning ring is provided on the connection rod, and the positioning ring is arranged around a circumference of the connection rod, and is provided between the fixed section and the insertion section; a diameter of the positioning ring is larger than a diameter of the installation section, and the functional component and installation section are respectively abutted against the positioning ring in opposite directions;

the threaded cylinder surrounds and forms a cylinder cavity, the installation section penetrates the cylinder cavity, the positioning ring is placed in the cylinder cavity, and the threaded cylinder is abutted against the positioning ring.

In some embodiments of the present disclosure, an abutting ring extending inward is formed on the threaded cylinder, and the abutting ring abuts against the positioning ring.

In some embodiments of the present disclosure, an elastic layer is provided on the positioning ring, and a plurality of concave grooves are provided on the elastic layer; a hollow ring is formed on the elastic layer, and the hollow ring is arranged around the positioning ring in a circumferential direction, and the hollow ring is arranged to face the positioning ring; the abutting ring is provided with a plurality of protruding blocks, and the protruding blocks are embedded in the concave grooves; the abutting ring abuts against the elastic layer and undergoes elastic compression deformation, and the hollow ring synchronously undergoes elastic compression deformation.

In some embodiments of the present disclosure, the threaded cylinder has an outer circumference surface arranged outward, and the outer circumference surface is provided with a plurality of anti-slip grooves, and the anti-slip grooves are arranged at intervals along a circumferential direction of the threaded cylinder, and extend along an axial direction of the threaded cylinder.

In some embodiments of the present disclosure, the heteroideus hole has a planar positioning inner wall, and the insertion section has a planar positioning outer wall; when the insertion section is inserted into the functional component, the positioning outer wall abuts against the positioning inner wall, and the positioning inner wall limits the functional component from rotating in a circumferential direction relative to the connection rod.

In some embodiments of the present disclosure, the functional component is a cane tip seat, and an outer circumference of the functional component is provided with mud support plates, and the mud support plates are arranged around a circumference of the cane tip seat, and the cane tip seat is provided with a cane tip.

In some embodiments of the present disclosure, the functional component is a camera bracket configured to connect with a camera, and the functional component is provided with a connection head configured to connect with the camera.

Compared with the existing technology, the multifunctional trekking pole provided by the present disclosure integrates the functional component with the cane tube through the connection rod and the threaded cylinder, and the heteroideus hole in the functional component can limit the rotation of the functional component relative to the connection rod. The threaded cylinder is connected to the functional component through threads, which can limit the axial movement of the functional component relative to the connection rod. The functional component can be separated from the cane tube, so that different functional components can be selected according to different needs to achieve multifunctional performance of the trekking pole.

### BRIEF DESCRIPTION OF DRAWINGS

FIG. 1 is a three-dimensional schematic diagram of a multifunctional hiking pole supporting a camera provided by the present disclosure.

FIG. 2 is an enlarged schematic diagram of point A in FIG. 1.

FIG. 3 is a three-dimensional schematic diagram of a camera bracket and a connection head provided by the present disclosure.

FIG. 4 is a three-dimensional schematic diagram of the multifunctional trekking pole provided by the present disclosure.

FIG. 5 is an enlarged schematic diagram of point B in FIG. 4.

FIG. 6 is a three-dimensional schematic diagram of a cane tip seat provided by the present disclosure.

FIG. 7 is a three-dimensional schematic diagram of a threaded cylinder provided by the present disclosure.

FIG. 8 is a three-dimensional schematic diagram of a connection rod provided by the present disclosure.

FIG. 9 is a partial schematic diagram of a fixed section provided by the present disclosure.

FIG. 10 is a partial schematic diagram of a connection between the fixed section and elastic strips provided by the present disclosure.

FIG. 11 is a schematic diagram of an arrangement of a plurality of elastic strips provided by the present disclosure.

FIG. 12 is a schematic sectional view of an elastic layer provided by the present disclosure.

FIG. 13 is a sectional schematic diagram of the threaded cylinder in contact with a positioning ring provided by the present disclosure.

### DESCRIPTION OF EMBODIMENTS

In order to further clarify the purpose, technical solution, and advantages of the present disclosure, the following will provide a detailed explanation of the present disclosure in combination with the accompanying drawings and embodiments. It should be understood that specific embodiments described herein are only used to explain the present disclosure and are not intended to limit the present disclosure.

The following provides a detailed description of the implementation of the present disclosure in combination with specific embodiments.

The same or similar reference numbers in the accompanying drawings of this embodiment correspond to the same or similar components. In the description of the present disclosure, it should be understood that if there are terms such as “up”, “down”, “left”, “right” indicating orientation or positional relationships based on the orientation or positional relationships shown in the accompanying drawings, it is only for the convenience of describing the present disclosure and simplifying the description, and does not indicate or imply that the device or component referred to must have a specific orientation, be constructed and operated in a specific orientation. Therefore, the expression used to describe positional relationships in the accompanying drawings is only for illustrative purposes and cannot be understood as a limitation of the present disclosure. For those skilled in the art, specific meanings of the above terms can be understood according to specific situations.

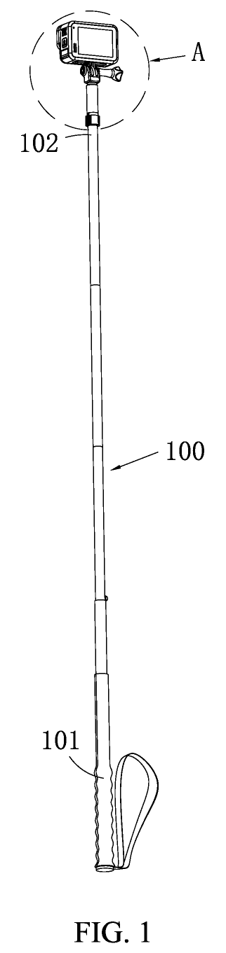

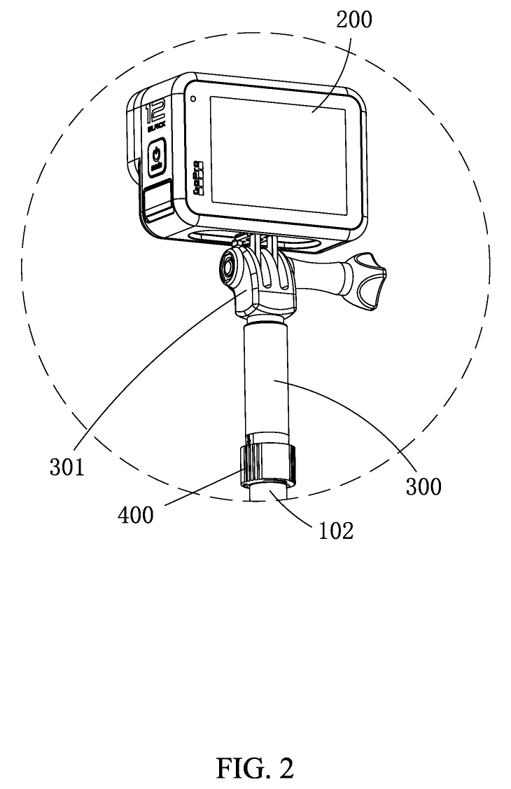

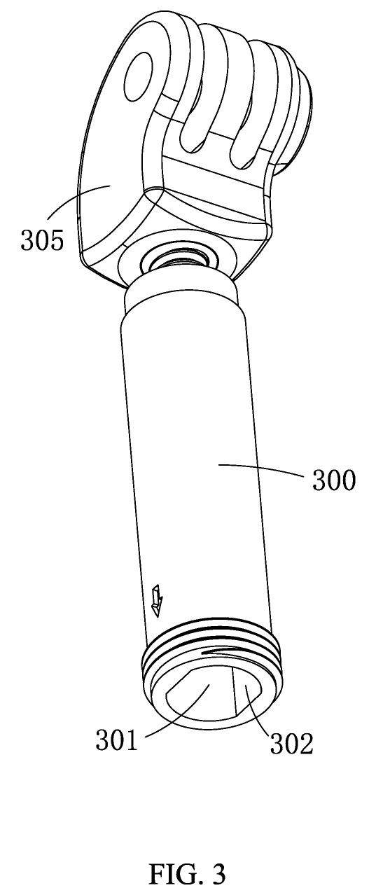

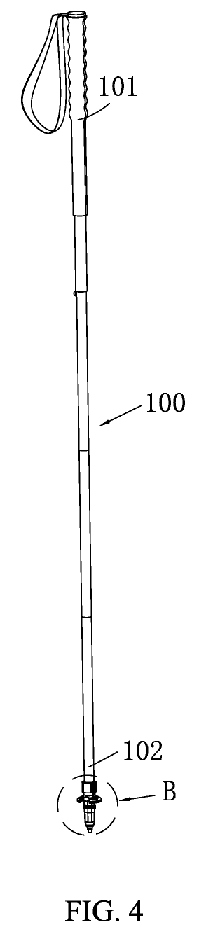

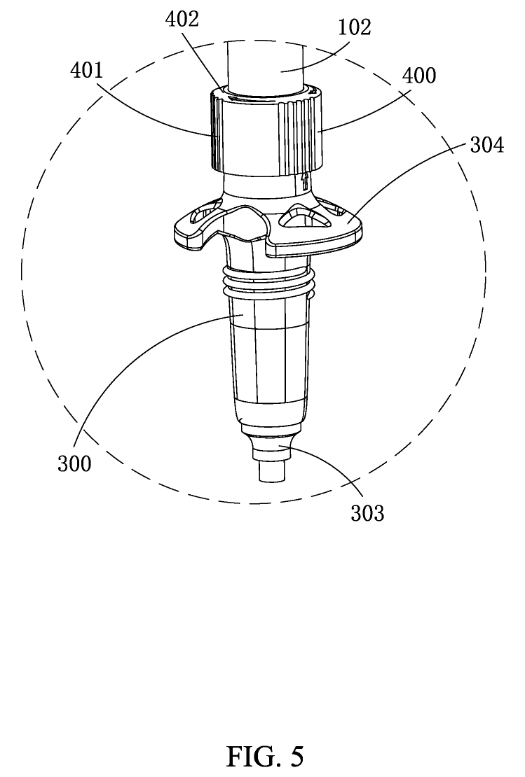

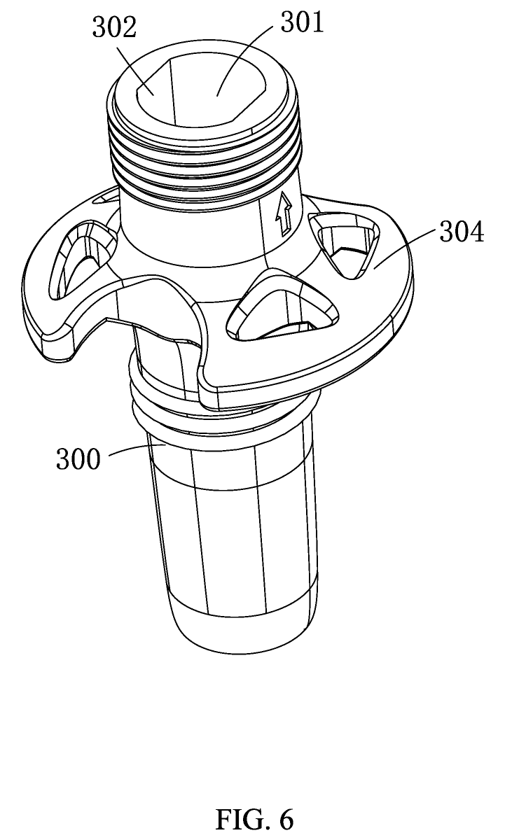

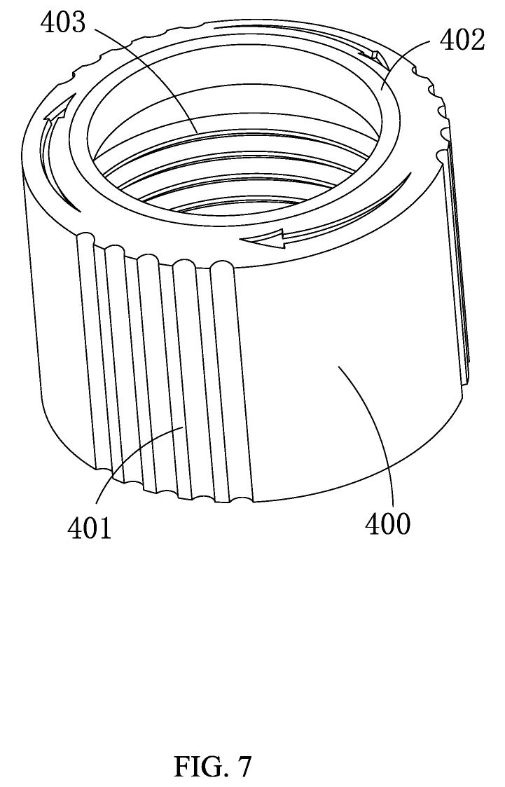

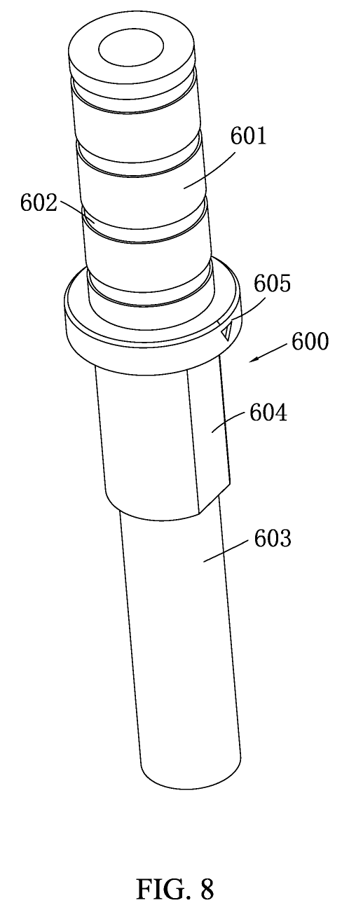

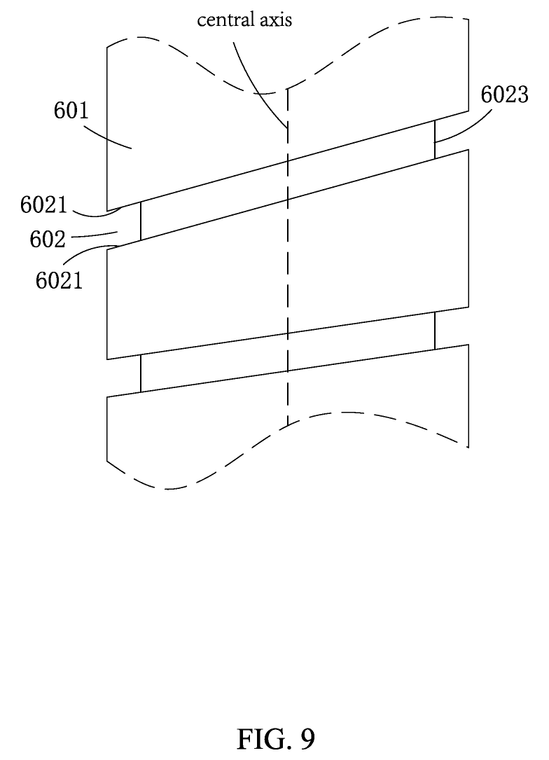

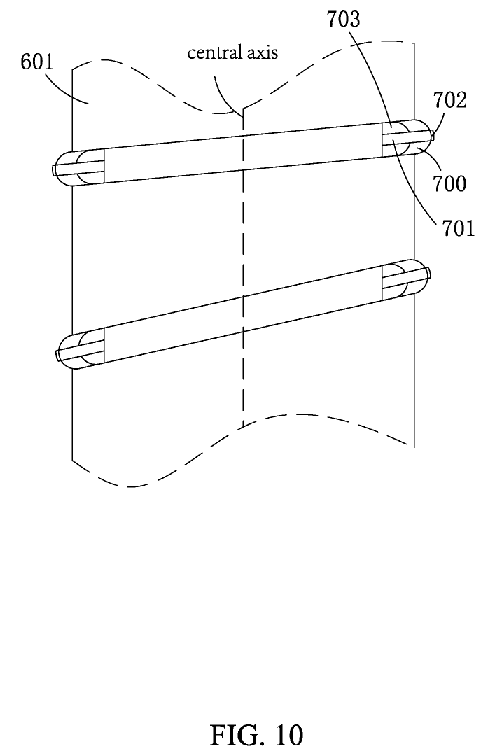

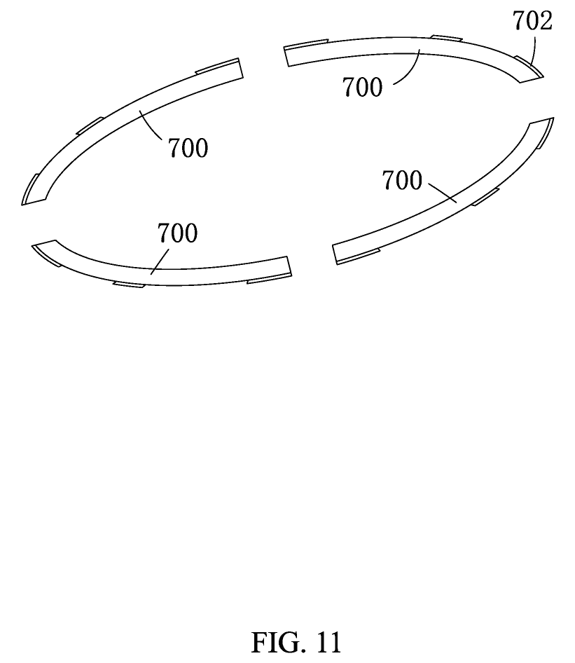

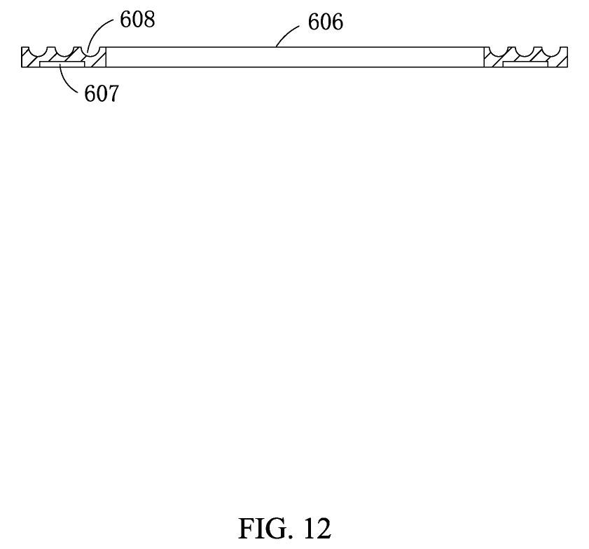

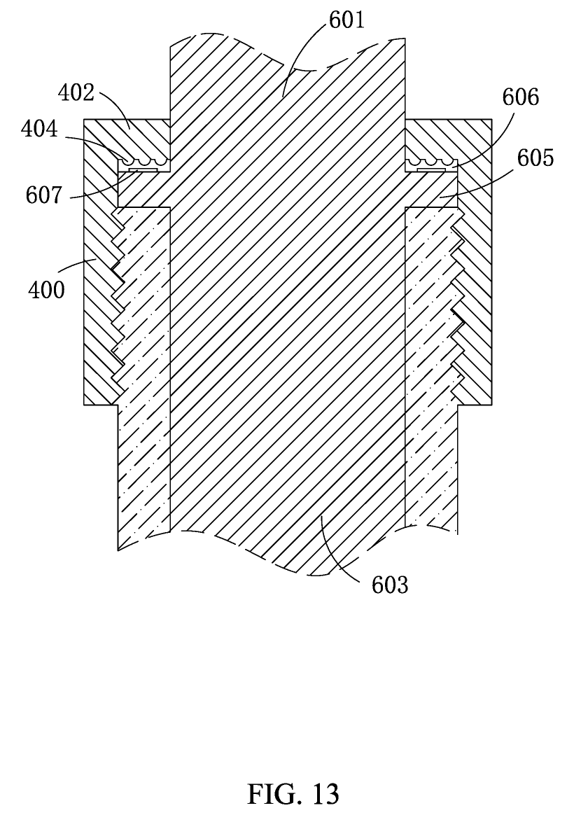

Referring to FIGS. 1-13, the preferred embodiment provided by the present disclosure is shown.

A multifunctional trekking pole, including a cane tube 100, a connection rod 600, and a replaceable functional component 300. One end of the cane tube 100 forms a handheld section 101, and the other end of the cane tube 100 forms an installation section 102; One end of the connection rod 600 forms a fixed section 601, and the other end of the connection rod 600 forms an insertion section 603. The functional components 300 can be diversified, and different functional components 300 can be configured according to different needs. During use, a user can directly hold the handheld section 101 with hands.

The fixed section 601 is inserted into the installation section 102, and the insertion section 603 is exposed outside of the installation section 102. The functional component 300 is provided with a heteroideus hole 301, and the insertion section 603 is inserted into the heteroideus hole 301. The heteroideus hole 301 restricts a circumferential rotation of the functional component 300 relative to the connection rod 600. In this way, when the insertion section 603 is inserted into the functional component 300, the functional component 300 and the insertion section 603 are fixed in the circumferential direction, and there will be no circumferential rotation phenomenon.

The installation section 102 is provided with a rotatable threaded cylinder 400, and the threaded cylinder 400 is threaded with the functional component 300 to restrict an axial movement of the functional component 300 relative to the connection rod 600, so as to connect the cane tube 100, the connection rod 600, and the functional component 300 as a whole.

Where, the fixed section 601 is inserted into the installation section 102 and fixedly connected to the installation section 102. It is not limited to fixing methods such as adhesive, elastic gasket, dot, etc., as long as a fixed connection between the fixed section 601 and the installation section 102 can be achieved.

The multifunctional trekking pole provided above, the functional component 300 is connected to the cane tube 100 through the connection rod 600 and the threaded cylinder 400, and the heteroideus hole 301 in the functional component 300 can limit the rotation of the functional component 300 relative to the connection rod 600. The threaded cylinder 400 is connected to the functional component 300 by threads, which can limit the axial movement of the functional component 300 relative to the connection rod 600. The functional component 300 and the cane tube 100 can be separated, so that different functional components 300 can be selected according to different needs to achieve multifunctional performance of the trekking pole.

In an implementation mode, a plurality of recess rings 602 are formed on an outer circumference of the fixed section 601, and the recess rings 602 are arranged around a circumference of the fixed section 601. The plurality of recess rings 602 are arranged at intervals along an axial direction of the fixed section 601. In this way, it is convenient for the fixed section 601 to be inserted into the installation section 102, and a multi ring contact is achieved between the fixed section 601 and the installation section 102, so that the fixed section 601 is firmly fixed in the installation section 102.

In an implementation mode, the recess rings 602 are arranged to be inclined to a central axis of the fixed section 601, and the plurality of recess rings 602 are inclined in different directions to a central axis of the fixed section 601. Bottoms of the recess rings 602 have a bottom ring walls 6023, and the two sides of the recess rings 602 have side ring walls 6021 respectively. The two side ring walls 6021 are arranged facing each other, and the two side ring walls 6021 surround the bottom ring walls 6023 to form the recess rings 602 described above.

There are a plurality of arc-shaped elastic strips 700 arranged in the recess rings 602, and the plurality of arc-shaped elastic strips 700 are arranged around a circumference of the recess rings 602 and spaced apart from each other. Two sides of the elastic strips 700 are respectively connected to the two side ring walls 6021, and there is a deformation gap 703 between the elastic strips 700 and the bottom ring walls 6023.

The deformation gap 703 is provided with a plurality of elastic columns 701, and bottoms of the elastic columns 701 are abutted against the bottom ring walls 6023. Tops of the elastic columns 701 pass through the elastic strips 700, and there is a hard pressing head 702 on the tops of the elastic columns 701.

The fixed section is inserted into the installation section 102, and the elastic strips 700 are compressed and deformed towards the bottom ring walls 6023. The plurality of elastic columns 701 are compressed and deformed synchronously, and a plurality of pressing head 702 are elastically pressed against the installation section 102, applying pressure to a plurality of positions of the installation section 102.

After the fixed section 601 is inserted into the installation section 102, it is compressed by the installation section 102, and the elastic strips 700 are compressed inwardly. The plurality of elastic columns 701 are compressed synchronously, and the deformation gap 703 is reduced. The pressing head 702 on the elastic columns 701 presses against the installation section 102 and applies reverse elastic pressure to the installation section 102, thereby stabilizing the fixed section 601 in the installation section 102.

Secondly, due to the inclined arrangement of the recess rings 602, the plurality of elastic strips 700 of the recess rings 602 are also arranged in an inclined manner simultaneously. Along the circumference of the recess rings 602, the pressing head 702 on the plurality of elastic columns 701 form multi position elastic compression on the installation section 102, applying elastic pressure at a plurality of positions to make the fixed section 601 more stably fixed in the installation section 102.

Besides that, the elastic pressure applied by the pressing heads 702 on the plurality of elastic columns 701 is arranged obliquely with the central axis of the fixed section 601, so that the fixed section 601 is fixed in an inclined force state in the installation section 102, rendering the fixation more stable.

In an implementation mode, the connection rod 600 is provided with a positioning ring 605, and the positioning ring 605 is arranged around a circumference of the connection rod 600. The positioning ring 605 is located between the fixed section 601 and the insertion section 603. A diameter of the positioning ring 605 is larger than that of the installation section 102, and the functional component 300 and the installation section 102 are respectively facing each other and adjacent to the positioning ring 605.

The threaded cylinder 400 surrounds to form a cylinder cavity 403, and the installation section 102 penetrates the cylinder cavity 403. The positioning ring 605 is placed in the cylinder cavity 403, and the threaded cylinder 400 abuts against the positioning ring 605.

When it is necessary to connect the functional component 300 with the cane tube 100, the insertion section 603 is inserted into the functional component 300, the threaded cylinder 400 is rotated forward, and the threaded cylinder 400 is connected to the functional component 300 by threads until the threaded cylinder 400 abuts against the positioning ring 605. At this point, the threaded cylinder 400 rotates to a connection limit position, and the functional component 300, the connection component, and the cane tube 100 are connected as one.

When it is necessary to detach the functional component 300 from the cane tube 100, that is, when the functional component 300 needs to be replaced, the threaded cylinder 400 is rotated in an opposite direction. At this time, the threaded cylinder 400 disengages from the contact with the positioning ring 605 until the threaded cylinder 400 disengages from the threaded connection with the functional component 300. Then, the functional component 300 can be pulled out from the insertion section 603.

In an implementation mode, an abutting ring 402 extending inward is formed on the threaded cylinder 400, and the abutting ring 402 abuts against the positioning ring 605. By arranging the abutting ring 402, it facilitates the contact between the abutting ring 402 and the positioning ring 605, and the threaded connection between the threaded cylinder 400 and the functional component 300 can be positioned at a limit position.

In an implementation mode, the positioning ring 605 is provided with an elastic layer 606, and the elastic layer 606 has a plurality of concave grooves 608. A hollow ring 607 is formed on the elastic layer 606, and the hollow rings 607 are arranged around a circumference of the positioning ring 605 and faces the positioning ring 605. There are a plurality of protruding blocks 404 on the abutting ring 402, and the protruding blocks 404 are embedded in the concave grooves 608. The abutting ring 402 abuts against the elastic layer 606 and undergoes elastic compression deformation, and the hollow ring 607 synchronously undergoes elastic compression deformation.

The protruding blocks 404 are embedded in the concave grooves 608, which can make the abutting ring 402 more stable when pressed against the elastic layer 606, so that the threaded cylinder 400 is more stable when connected to the functional component 300. Secondly, the elastic layer 606 undergoes elastic compression under compression, applying a reverse elastic force to the threaded cylinder 400, which can make the threaded connection between the threaded cylinder 400 and the functional component 300 more stable. Furthermore, by arranging the hollow rings 607, during the rotation of the threaded cylinder 400, the abutting ring 402 can better press against the elastic layer 606 for elastic compression deformation.

In an implementation mode, the threaded cylinder 400 has an outward facing outer circumference surface, and the outer circumference surface is provided with a plurality of anti-slip grooves 401. The plurality of anti-slip grooves 401 are arranged at intervals along the circumferential direction of the threaded cylinder 400, and the anti-slip grooves 401 extend along the axial direction of the threaded cylinder 400. In this way, it is convenient for a user to operate the threaded cylinder 400 for rotation, to connect the threaded cylinder 400 with the functional component 300 or detach it from the functional component 300.

In an implementation mode, the heteroideus hole 301 has a planar positioning inner wall 302, and the insertion section 603 has a planar positioning outer wall 604. When the insertion section 603 is inserted into the functional component 300, the positioning outer wall 604 abuts against the positioning inner wall 302, and the positioning inner wall 302 limits the circumferential rotation of the functional component 300 relative to the connection rod 600.

By arranging the contact between the planar positioning inner wall 302 and the positioning outer wall 604, the rotation of the functional component 300 relative to the connection rod 600 can be limited, and the insertion section 603 can be guided and positioned into the heteroideus hole 301.

In an implementation mode, the functional component 300 is a cane tip seat, and an outer circumference of the functional component 300 is provided with mud support plates 304. The mud support plates 304 are arranged around a circumference of the cane tip seat, and a cane tip 303 is provided on the cane tip seat. During the use of the trekking pole, the mud support plates 304 can act as a barrier against soil. If the cane tip seat is inserted too deeply into the soil, it will facilitate the use of the trekking pole.

In an implementation mode, the functional component 300 is a camera bracket for connecting with a camera, and the functional component 300 is provided with a connector head 305 for connecting with the camera. When the trekking pole is not used as an auxiliary walking tool, it can be used to support the camera, and the camera is connected to the connector head 305, and the user can hold the handled section 101 with hand. Using the trekking pole, the camera can be raised to achieve a higher effect.

The above description is only a preferred embodiment of the present disclosure and is not intended to limit the present disclosure. Any modifications, equivalent substitutions, and improvements made within the spirit and principles of the present disclosure should be included within the protection scope of the present disclosure.

What is claimed is:

1. A multifunctional trekking pole, comprising: a cane tube, a connection rod, and a replaceable functional component, wherein one end of the cane tube forms a handheld section, and the other end of the cane tube forms an installation section; one end of the connection rod forms a fixed section, and the other end of the connection rod forms an insertion section;
the fixed section is inserted into the installation section, and the insertion section is exposed outside the installation section; the functional component is provided with a heteroideus hole, and the insertion section is inserted into the heteroideus hole, the heteroideus hole limits a circumferential rotation of the functional component relative to the connection rod;
the installation section is provided with a rotatable threaded cylinder, and the threaded cylinder is connected to the functional component by threads, thereby limiting an axial movement of the functional component relative to the connection rod, and the cane tube, the connection rod, and the functional component are connected.

2. The multifunctional trekking pole according to claim 1, wherein a plurality of recess rings are formed on an outer circumference of the fixed section, the plurality of recess rings are arranged around a circumference of the fixed section, and the plurality of recess rings are arranged at intervals along an axial direction of the fixed section.

3. The multifunctional trekking pole according to claim 2, wherein the plurality of recess rings are arranged at inclined to a central axis of the fixed section, and the plurality of recess rings are inclined in different directions from a central axis of the fixed section; bottoms of the recess rings have bottom ring walls, and two sides of the recess rings have side ring walls respectively;
two of the side ring walls are arranged facing each other, and the two side ring walls surround the bottom ring walls to form the recess rings;
the recess rings are provided with a plurality of arc-shaped elastic strips, and the plurality of arc-shaped elastic strips are arranged around a circumference of the recess rings and spaced apart from each other;
two sides of the elastic strips are respectively connected to the two side ring walls, and there is a deformation gap between the elastic strips and the bottom ring walls;
the deformation gap is provided with a plurality of elastic columns, and bottoms of the elastic columns are connected to the bottom ring walls;
tops of the elastic columns pass through the elastic strips, and a hard pressing head is provided on the tops of the elastic columns;
the fixed section is inserted into the installation section, and the elastic strips are compressed and deformed towards the bottom ring walls;
the plurality of elastic columns are compressed and deformed synchronously, and a plurality of pressing heads are elastically abutted against the installation section, applying pressure to a plurality of positions on the installation section.

4. The multifunctional trekking pole according to claim 1, wherein a positioning ring is provided on the connection rod, and the positioning ring is arranged around a circumference of the connection rod, and is provided between the fixed section and the insertion section;
a diameter of the positioning ring is larger than a diameter of the installation section, and the functional component and installation section are respectively abutted against the positioning ring in opposite directions;
the threaded cylinder surrounds and forms a cylinder cavity, the installation section penetrates the cylinder cavity, the positioning ring is placed in the cylinder cavity, and the threaded cylinder is abutted against the positioning ring.

5. The multifunctional trekking pole according to claim 4, wherein an abutting ring extending inward is formed on the threaded cylinder, and the abutting ring abuts against the positioning ring.

6. The multifunctional trekking pole according to claim 5, wherein an elastic layer is provided on the positioning ring, and a plurality of concave grooves are provided on the elastic layer;
a hollow ring is formed on the elastic layer, and the hollow ring is arranged around the positioning ring in a circumferential direction, and the hollow ring is arranged to face the positioning ring;
the abutting ring is provided with a plurality of protruding blocks, and the protruding blocks are embedded in the concave grooves;
the abutting ring abuts against the elastic layer and undergoes elastic compression deformation, and the hollow ring synchronously undergoes elastic compression deformation.

7. The multifunctional trekking pole according to claim 1, wherein the threaded cylinder has an outer circumference surface arranged outward, and the outer circumference surface is provided with a plurality of anti-slip grooves, and the anti-slip grooves are arranged at intervals along a circumferential direction of the threaded cylinder, and extend along an axial direction of the threaded cylinder.

8. The multifunctional trekking pole according to claim 1, wherein the heteroideus hole has a planar positioning inner wall, and the insertion section has a planar positioning outer wall;
when the insertion section is inserted into the functional component, the positioning outer wall abuts against the positioning inner wall, and the positioning inner wall limits the functional component from rotating in a circumferential direction relative to the connection rod.

9. The multifunctional trekking pole according to claim 1, wherein the functional component is a cane tip seat, and an outer circumference of the functional component is provided with mud support plates, and the mud support plates are arranged around a circumference of the cane tip seat, and the cane tip seat is provided with a cane tip.

10. The multifunctional trekking pole according to claim 1, wherein the functional component is a camera bracket configured to connect with a camera, and the functional component is provided with a connection head configured to connect with the camera.
